(19) United States
(12) Patent Application Publication
(10) Pub. No.: US 2005/0135568 A1
(43) Pub. Date: Jun. 23, 2005

(54) Efficient and reduced-complexity training algorithms

(76) Inventor: Sigang Qiu, Cupertino, CA (US)

Correspondence Address: Libby H. Hope;BLAKELY, SOKOLOFF, TAYLOR & ZAFMAN LLP, Seventh Floor, 12400 Wilshire Boulevard, Los Angeles, CA, 90025, US

(21) Appl. No.: 10/745,901

(22) Filed: Dec. 23, 2003

(51) Int. Cl. H04M 1/24

(52) U.S. Cl. 379/27.01

(57) ABSTRACT

In one embodiment, a method is provided. The method of this embodiment provides receiving a communication having a data sample set, generating a selective data sample set based, at least in part, on the data sample set, and using the selective data sample set to update a training algorithm using an updating algorithm.

### CROSS-REFERENCE TO RELATED APPLICATION

The subject application is related to co-pending U.S. patent application Ser. No. 10/644,229 (Attorney Docket No.: P16581), filed on Aug. 20, 2003, entitled “Methods and Apparatus for Characterizing Subscriber Loop Based On Analysis of DSL Handshaking Signals and For Optimization of DSL Operation”, which co-pending application is assigned to the same Assignee as the subject application.

### FIELD

Embodiments of this invention relate to efficient and reduced-complexity training algorithms.

### BACKGROUND

Communications between communication devices may comprise four phases: handshaking, training, exchange, and data mode. During the handshaking phase, common working mode capabilities, such as data transport method, data transport version, and signaling family, for examples, may be negotiated. Since one or more characteristics of the communication channel may be unknown (e.g., the capacity of the channel and throughput) by a receiving communication device, the receiving communication device may use training algorithms to determine one or more of the channel characteristics. In the exchange phase, the communication devices may exchange data mode parameters to be used to transmit actual data in the data mode phase. In the data mode phase, transmission of actual data between the two communication devices may occur in accordance with data mode parameters acquired in the exchange phase.

Of these phases, the training phase may be the most complex and resource-intensive phase. For example, a training algorithm such as a TDQ (time domain equalizer) algorithm used in a receiving communication device such as an ADSL (asymmetric digital subscriber line) modem, for example, may utilize more than 45% of CPU (central processing unit) processing resources in a 1.5 GHz (Gigahertz) machine. Furthermore, updating algorithms used in training algorithms, such as the LMS (least means square) algorithm, which may use all data samples to estimate channel characteristics, may also utilize undesirably large amounts of processing and memory resources.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network.

FIG. 2 illustrates a system.

FIG. 3 illustrates a system embodiment of the system in FIG. 2.

FIG. 4 illustrates communication phases according to one embodiment.

FIG. 5 is a flowchart illustrating a method according to one embodiment.

FIG. 6 is a flowchart illustrating a method according to another embodiment.

### DETAILED DESCRIPTION

Embodiments of the present invention include various operations, which will be described below. The operations associated with embodiments of the present invention may be performed by hardware components or may be embodied in machine-executable instructions, which when executed may result in a general-purpose or special-purpose processor or circuitry programmed with the machine-executable instructions performing the operations. Alternatively, and/or additionally, some or all of the operations may be performed by a combination of hardware and software.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Introduction

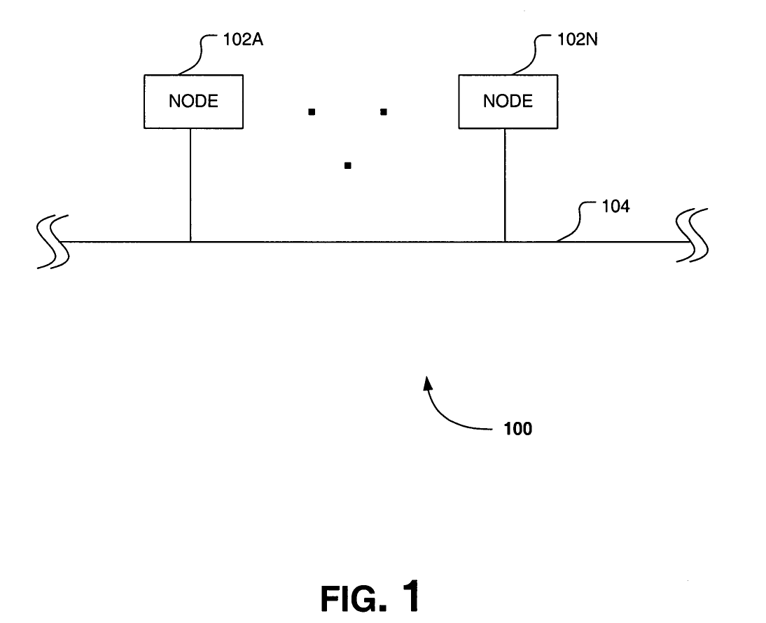

FIG. 1 illustrates one example of a network 100 in which embodiments of the invention may be carried out. Network 100 may comprise, for example, one or more computer nodes 102A . . . 102N (hereinafter “nodes”) communicatively coupled together via a communication medium 104. Nodes 102A . . . 102N may transmit and receive sets of one or more signals via medium 104 that may encode one or more packets. As used herein, a “packet” means a sequence of one or more symbols and/or values that may be encoded by one or more signals transmitted from at least one sender to at least one receiver.

As used herein, a “communication medium” means a physical entity through which electromagnetic radiation may be transmitted and/or received. Medium 104 may comprise, for example, one or more optical and/or electrical cables, although many alternatives are possible. For example, medium 104 may comprise air and/or vacuum, through which nodes 102A . . . 102N may wirelessly transmit and/or receive sets of one or more signals.

In network 100, one or more of the nodes 102A . . . 102N may comprise one or more intermediate stations, such as, for example, one or more hubs, switches, and/or routers; additionally or alternatively, one or more of the nodes 102A . . . 102N may comprise one or more end stations. Also additionally or alternatively, network 100 may comprise one or more not shown intermediate stations, and medium 104 may communicatively couple together at least some of the nodes 102A . . . 102N and one or more of these intermediate stations. Of course, many alternatives are possible.

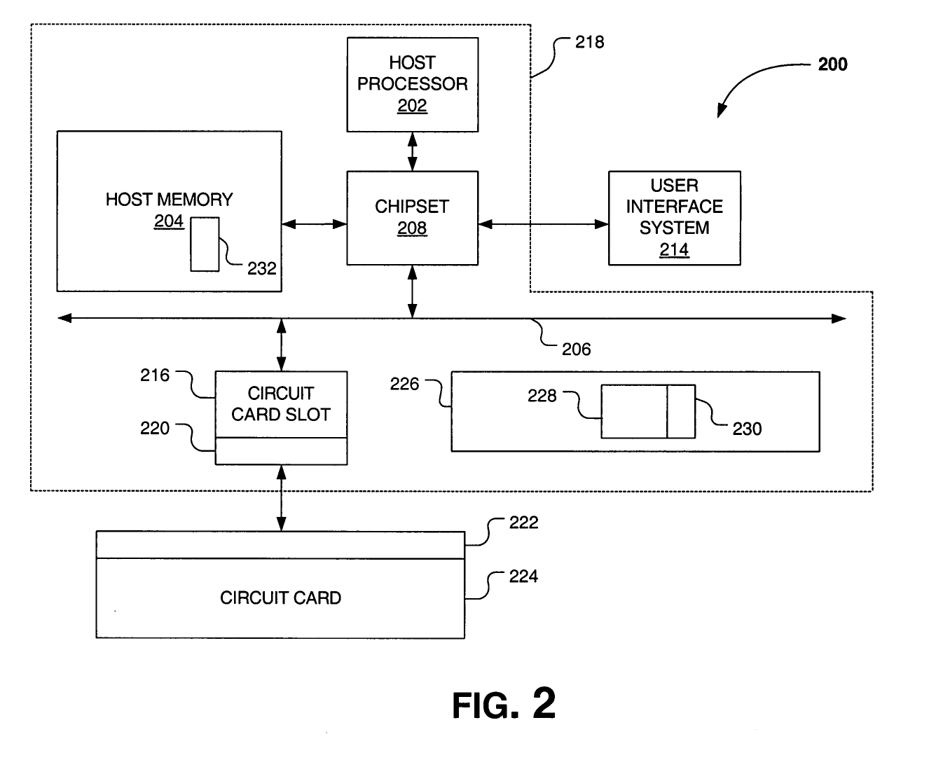

FIG. 2 illustrates system 200, which may comprise a node 102A . . . 102N in network 100. System 200 may comprise host processor 202, host memory 204, bus 206, and chipset 208. Host processor 202 may comprise, for example, an Intel® Pentium®microprocessor that is commercially available from the Assignee of the subject application. Of course, alternatively, host processor 202 may comprise another type of microprocessor, such as, for example, a microprocessor that is manufactured and/or commercially available from a source other than the Assignee of the subject application, without departing from this embodiment.

Host processor 202 may be communicatively coupled to chipset 208. As used herein, a first component that is “communicatively coupled” to a second component shall mean that the first component may be capable of communicating with the second component via wirelined (e.g., copper wires), or wireless (e.g., radio frequency) means. Chipset 208 may comprise a host bridge/hub system that may couple host processor 202, host memory 204, and a user interface system 214 to each other and to bus 206. Chipset 208 may also include an I/O bridge/hub system (not shown) that may couple the host bridge/bus system 208 to bus 206. Chipset 208 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used. User interface system 214 may comprise, e.g., a keyboard, pointing device, and display system that may permit a human user to input commands to, and monitor the operation of, system 200.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 206 instead may comprise a bus that complies with the PCI-X Specification Rev. 1.0a, Jul. 24, 2000, available from the aforesaid PCI Special Interest Group, Portland, Oreg., U.S.A. (hereinafter referred to as a ‘PCI-X bus”). Also, alternatively, bus 206 may comprise other types and configurations of bus systems.

Host processor 202, host memory 204, bus 206, chipset 208, and circuit card slot 216 may be comprised in a single circuit board, such as, for example, a system motherboard 218. Circuit card slot 216 may comprise a PCI expansion slot that comprises a PCI bus connector 220. PCI bus connector 220 may be electrically and mechanically mated with a PCI bus connector 222 that is comprised in circuit card 224. Circuit card slot 216 and circuit card 224 may be constructed to permit circuit card 224 to be inserted into circuit card slot 216. When circuit card 224 is inserted into circuit card slot 216, PCI bus connectors 220, 222 may become electrically and mechanically coupled to each other. When PCI bus connectors 220, 222 are so coupled to each other, operative circuitry in circuit card 224 may become electrically coupled to bus 206. Although not shown, system 200 may include a plurality of cards, identical in construction and/or operation to circuit card 224, coupled to bus 206 via a plurality of circuit card slots identical in construction and/or operation to circuit card slot 216.

System may comprise circuitry 226. Circuitry 226 may comprise one or more circuits to perform one or more operations described herein as being performed by circuitry 226. Circuitry 226 may be hardwired to perform the one or more operations, and/or may execute machine-executable instructions to perform these and/or other operations. For example, circuitry 226 may comprise memory 228 that may store machine-executable instructions 230 that may be executed by circuitry 226 to perform these operations. Instead of being comprised in motherboard 218, some or all of circuitry 226 may be comprised in host processor 202, circuit card 224, and/or other structures, systems, and/or devices that may be, for example, comprised in motherboard 218, and/or coupled to bus 206, and may exchange data and/or commands with one or more other components in system 200. For example, chipset 208 may comprise one or more integrated circuits that may comprise some or all of circuitry 226. Circuitry 226 may comprise, for example, one or more digital circuits, one or more analog circuits, one or more state machines, programmable circuitry, and/or one or more ASIC's (application specific integrated circuits).

System 200 may comprise one or more memories to store machine-executable instructions 230, 232 capable of being executed, and/or data capable of being accessed, operated upon, and/or manipulated by circuitry, such as circuitry 226. For example, these one or more memories may include host memory 204, and/or memory 228. One or more memories 204 and/or 226 may comprise, for example, read only, mass storage, random access computer-readable memory, and/or one or more other types of machine-readable memory. The execution of program instructions 230, 232 and/or the accessing, operation upon, and/or manipulation of this data by circuitry 226 may result in, for example, circuitry 226 carrying out some or all of the operations described herein.

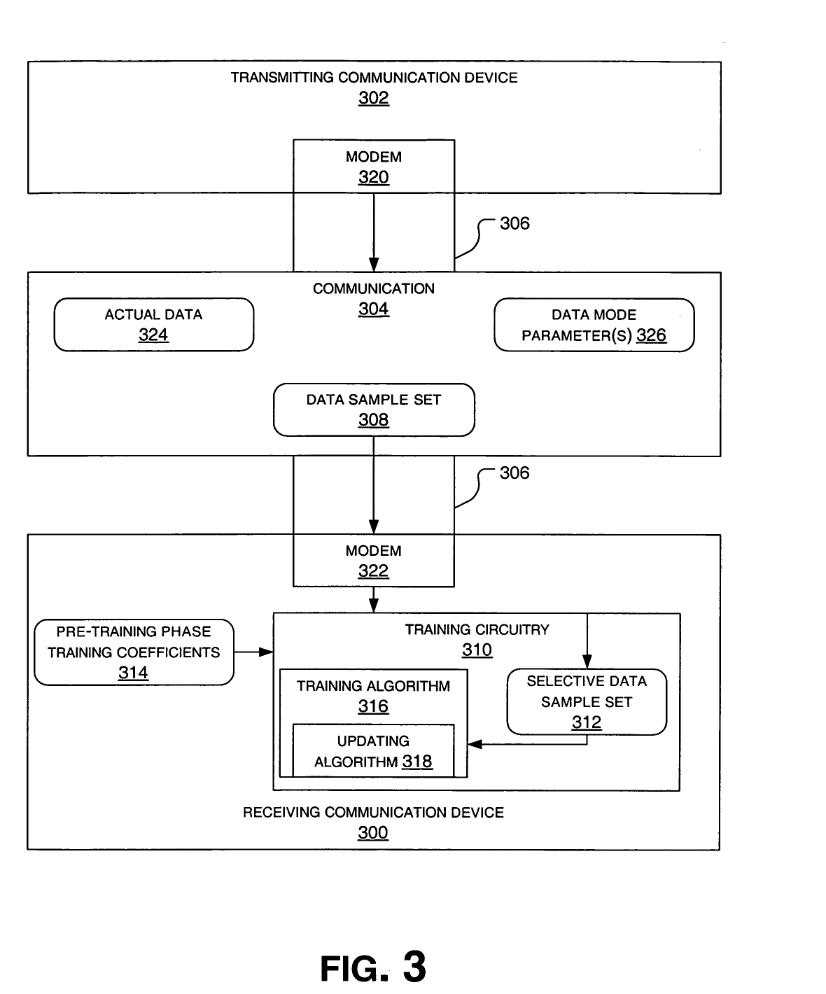

As illustrated in FIG. 3, system 200 may include a receiving communications device 300. Receiving communications device 300 may manage one or more communications 304 that may be transmitted from sending communication device 302 over communication channel 306. Transmitting communication device 302 and receiving communication device 300 may each comprise, for example, a respective modem 320, 322 that may be comprised in circuitry 226 of system 200. There are other possibilities. For example, transmitting communication device 302 may comprise a hub, and receiving communication device 300 may comprise a PC (personal computer). As another example, transmitting communication device 302 may comprise a base station, and receiving communication device 300 may comprise a substation. Transmitting communication device 302 may be located on, for example, another system that may be similar in construction and/or operation to system 200.

Each of the one or more communications 304 may comprise actual data 324, data mode parameters 326, and data sample set 308. “Actual data” refers to information that may be transmitted from a device, such as transmitting communication device 302, that may ultimately be received by a device, such as receiving communication device 300 during, for example, in a data mode phase. In contrast, “data sample set” may comprise one or more data samples to be used by a device, such as a receiving communication device 300, during a training phase, for example. “Data samples” may comprise data provided and transmitted by a device, such as transmitting communication device 302, for purposes of training a device, such as receiving communication device 300. Also in contrast, “data mode parameters” may comprise information obtained in an exchange phase that may be used in a data mode phase to transmit actual data. The described phases are illustrative, and are not meant to limit embodiments of the invention. These phases are described in detail below.

“Communication channel” refers to a path by which one or more communications 304 may be transmitted. For example, communication channel 306 may comprise one or more carrier frequencies via which one or more communications 304 may be modulated. Communication channel may be associated with one or more channel characteristics. One or more channel characteristics may include impairments, such as loop length, cross-talk, and bridge-taps, as well as channel capabilities, such as channel capacity, and throughput. For example, a communication channel 306 may have a maximum capacity of 80 Mbps (megabits per second), but a throughput of 50 Mbps. Also, communication channel 306 may be associated with a loop length, such as the distance between the receiving communication device 306 and the transmitting communication device 302 on a given channel; interference, such as ISI (intersymbol interference), ICI (interchannel interference), cross-talk, and echo; and bridge-taps, such as extraneous cable on a communications line.

Since any number of the one or more characteristics of communication channel 306 may affect transmission of communications 304 on communication channel 306, and may not be known to receiving communication device 300, receiving communication device 300 may determine one or more of the one or more characteristics of the communication channel 306. As used herein, “determine” shall mean to estimate, find, calculate, or otherwise obtain, directly or indirectly. For example, one or more characteristics may be determined by estimating the one or more characteristics, calculating the one or more characteristics, and/or estimating one or more other characteristics to determine the one or more characteristics.

Receiving communication device 300 may comprise training circuitry 310, which may use one or more training algorithms 316 (only one shown). As used herein, a “training algorithm” refers to a method to determine one or more characteristics of a communication channel by using an updating algorithm. An “updating algorithm”, as used herein, refers to a method to converge training coefficients, thereby stabilizing the training coefficients. A “training coefficient” refers to a characteristic of a communication channel that may be measured, and that may change, but which may be stabilized over time, or under a certain set of conditions. Each training algorithm may be characterized by a set of training coefficients. By stabilizing a set of training coefficients, one or more characteristics of the communication channel 306 that correspond to the set of training coefficients may be reliably determined. Training circuitry 310 may use one or more training algorithms 316 to determine one or more characteristics of communication channel 306.

Training algorithm 316 may comprise, for example, a TDQ algorithm, a frequency domain equalizing algorithm, and an echo canceller algorithm. Updating algorithms 318 that may be used by a training algorithm may comprise, for example, a LMS (least mean square), or a RLS (recursive least square) algorithm. Training circuitry 310 may be comprised in circuitry such as circuitry 226.

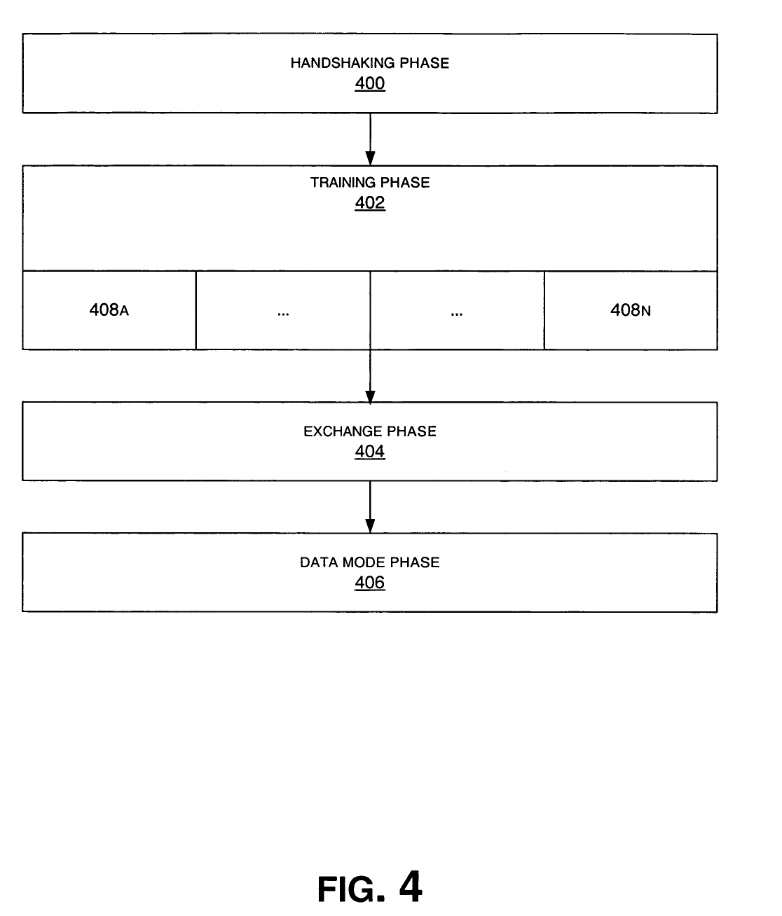

In one embodiment, communication 304 between transmitting communication device 302 and receiving communication device 300 may occur in a plurality of communication phases. As one of ordinary skill would appreciate, the plurality of communication phases may vary, where variations may depend on, for example, the type of communication devices used. Variations in communication phases, however, may be used without departing from embodiments of the invention. FIG. 4 illustrates exemplary phases that are used to illustrate one embodiment of the invention. FIG. 4 illustrates a handshaking phase 400, training phase 402, exchange phase 404, and data mode phase 406.

In handshaking phase 400, circuitry, such as circuitry 226, may negotiate common working mode capabilities with transmitting communication device 306. For example, an ATM (asynchronous transfer mode) packet transport method and a particular carrier frequency may be negotiated. Furthermore, circuitry, such as circuitry 226, may generate a set of pre-training phase training coefficients 314. “Pre-training phase training coefficients” may refer to one or more sets of training coefficients that may be determined prior to the training phase 402. Using pre-training phase training coefficients may help to accelerate convergence and promote stability of training coefficients, as well as avoid divergences of a training algorithm.

For example, training coefficients for an equalizer algorithm (such as a TDQ equalizing algorithm or a frequency domain equalizing algorithm) performed during a training phase may be pre-set based on an estimated loop length as determined in the handshaking phase 400. As other examples, training coefficients for timing (clock) recovery and/or automatic gain control functions performed during a training phase may be pre-set based on the estimated loop length as determined in the handshaking phase 400. One or more methods for determining an estimated loop length are described in co-pending, related application entitled “Method and Apparatus For Characterizing Subscriber Loop Based On Analysis of DSL Handshaking Signals and For Optimization of DSL Operation”, referred to above.

Using the negotiated common working mode capabilities, training circuitry 310 may receive data sample set 308. For example, data sample set 308 may be received as ATM packets on a negotiated carrier frequency. Training circuitry 310 may also obtain training coefficients, and generate selective data sample set 312 in training phase 402. In one embodiment, training circuitry 310 may obtain pre-training phase training coefficients 314. Pre-training phase training coefficients 314 and selective data sample set 312 may be used to update training algorithm 316. Training phase 402 may also comprise a plurality of training periods 408A, . . . , 408N.

When training algorithm 316 completes, receiving communication device 300 may use one or more channel characteristics to determine one or more other channel characteristics, and/or may use one or more channel characteristics to enable communication channel 306 to transmit actual data 324 in one or more subsequent phases, such as during data mode phase 406. In the exchange phase 404, circuitry may exchange data mode parameters 326 with transmitting communication device 306. Data mode parameters 326 may include, for example, encoder/decoder parameters such as the number of bytes corrected. In the data mode phase 406, receiving communication device 302 may receive actual data 324 in accordance with data mode parameters 326 acquired in the exchange phase 404.

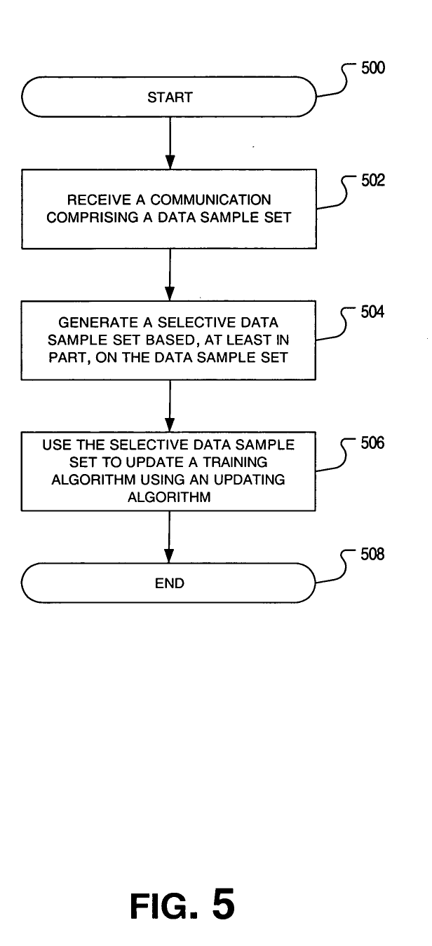

FIG. 5 is a flowchart illustrating a method according to one embodiment. The method begins at block 500 and continues to block 502 where training circuitry 310 may receive a communication 304 comprising a data sample set 308. At block 504, training circuitry 310 may generate a selective data sample set 312 based, at least in part, on data sample set 308. At block 506, training circuitry 310 may use selective data sample set 308 to update a training algorithm 316 using an updating algorithm 318. The method ends at block 508.

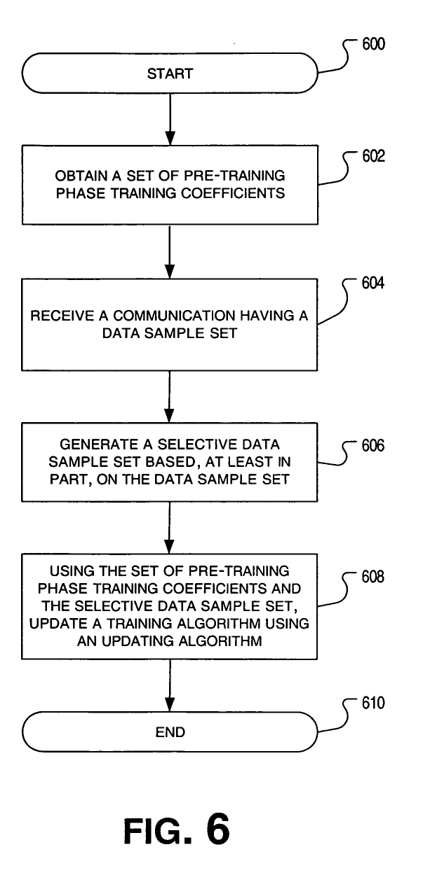

FIG. 6 is a flowchart illustrating a method according to another embodiment. The method begins at block 600 and continues to block 602 where training circuitry 310 may obtain a set of pre-training phase training coefficients 314. At block 604, training circuitry 310 may receive a communication 304 having a data sample set 308. At block 606, training circuitry 310 at block 606 may generate a selective data sample set 312 based, at least in part, on the data sample set 308. At block 608, training circuitry 310 may use the set of pre-training phase training coefficients 314 and the selective data sample set 312 to update a training algorithm 316 using an updating algorithm 318. The method ends at block 610.

Training circuitry 310 used in training phase 402, and circuitry used in other communication phases 400, 404, 406 may be the same circuitry, or different circuitry. For example, circuitry used in other communication phase 400, 404, 406 may be comprised in circuitry of receiving communication device 300, and training circuitry 310 may be comprised in circuitry of host processor 202. Another possibility is that circuitry used in all communication phases 500, 502, 504, 506, including training circuitry 316 may be comprised in receiving communication device 302. Other possibilities may exist.

Selective Sampling

Updating algorithm may use data samples to stabilize training coefficients. Assuming communication 304 may comprise data sample set 308, X={x[i], i=0, 1, . . . , M−1}, and T training periods 408A, . . . , 408N during training phase 402, the following are examples of methods for generating selective data sample set 312, Y={y[i], i=0, 1, . . . , N−1}, where N<=M, that may be provided to updating algorithm 318 for a given training period 408A, . . . , 408N in T.

As part of operations that may be performed in block 504 (FIG. 5), and block 606 (FIG. 6), training circuitry 310 may select data from data sample set 308, X, for each training period 408A, . . . , 408N in T. Using this method, data x[i] may be selected from X, such that Y comprises a subset of data x[i] from X, or such that Y comprises data based on an average of data selected from X. Using this method, selective sample data set 312 may comprise a subset of data from data sample set 308 in each training period 408A, . . . , 408N in T.

As part of operations that may be performed in block 504 (FIG. 5), and block 606 (FIG. 6), training circuitry 310 may select data from data sample set 308 in selected training periods: T training periods 408A, . . . , 408N may be divided into S subperiods, S(m), where ΣS(m)=T. Rather than sample every training period in T, data x[i] may be selected every T/P training period (where P may be any positive number), and where each T/P training period is a selected training period such that U comprises the total set of selected training periods, and U⊂T. For example, if T=1000 (i.e., 1000 training periods in a training phase), and P is 4, then T/P=250, and selective data sample set 312 may comprise data x[i] from X for every 250^{th} subperiod S(250). Using this method, selective data sample set 312 for any given selected training period may comprise all data in X, or it may comprise a subset of data in X (which may be generated as discussed above) in each selected training period in U.

As part of operations that may be performed in block 506 (FIG. 5), and block 608 (FIG. 6), selective data sample set 312 may be used by an updating algorithm 318 in one or more training periods in T. Thus, if data is selected each training period in T, then selective data sample set 312 may comprise subset of data sample set 308 in each training period in T. If data is selected in selected training periods in U, selective data sample set 312 may comprise selected data (subset or full set from X) from data sample set 308 in each selected training period in U.

Exemplary Embodiment

In an exemplary embodiment, an ADSL (Asymmetric Digital Subscriber Line) modem may receive a communication 304, and may use a TDQ training algorithm, for example, to estimate one or more characteristics of communication channel 306, such as a carrier frequency, on which communication 304 is transmitted. Selective data sample set 312 may be generated to train the TDQ training algorithm using an updating algorithm such as LMS, for example. Furthermore, one or more sets of pre-training phase training coefficients 314 may be used.

In one embodiment, the ADSL modem may operate in accordance with G.992.1 (hereinafter referred to as “G.992.1 ADSL”), an industry standard approved by the ITU (International Telecommunications Union). The specification for this standard may be described in “Assymetric digital subscriber line (ADSL) transceivers”, ITU-T Recommendation G.992.1 (06/99). G.992.1 specifies standards for full-rate ADSL operation of up to 10 Mbps (megabits per second) downstream, and up to 768 kbps (kilobits) upstream when operating over telephone lines at distances of up to 18,000 feet. This is just one example, and numerous other possibilities may exist. For example, ADSL modem may operate in accordance with other standards, such as may be provided by ITU, and/or other entities, organizations, and/or unions, for example. Also, selective data sample set 312 may be generated in any type of communication device to train other training algorithms, which may use other updating algorithms.

In G.992.1 ADSL, a data sample set 308 may be referred to as a symbol. Each symbol may comprise data samples, X={x[i], i=0, 1, . . . , m−1}, where M=512 for an ADSL G.992.1 system. The total number of training periods, T, 408A, . . . , 408N during training phase 402 may be greater than 1000 for TDQ training. In G.992.1 ADSL, T may be as large as 2560 training periods, although the training periods may be adjustable and vendor-specific. Selective data sample set 312, Y={y[i], i=0, 1, . . . , N−1}, where N<=M for a given period in T, may be generated for TDQ in G.992.1 ADSL using one of the following methods:

As part of operations that may be performed in block 504 (FIG. 5), and block 606 (FIG. 6), training circuitry 310 may select data from data sample set 308, X, for each training period 408A, . . . , 408N in T. Using this method, data x[i] may be selected from X, such that Y comprises a subset of data x[i] from X. In TDQ, the training algorithm may be performed on either the even numbered symbols or the odd numbered symbols, for example, to generate a subset of data sample set 308. Furthermore, since ADSL may comprise 32 upstream carrier subchannels (0-31), and 256 downstream carrier subchannels (0-255), downstream carrier subchannels may start from carrier subchannel 32. In this example, therefore, TDQ training may be performed on samples of x[i], where i>31 per symbol.

Alternatively, for each training period 408A, . . . , 408N in T, select data x[i] from X, such that Y comprises data based on an average of data selected from X. Using this method, one or more subsets of data sample set 308 may be collected and averaged. Each average of a subset may be placed into Y.

As part of operations that may be performed in block 504 (FIG. 5), and block 606 (FIG. 6), training circuitry 310 may select data from data sample set 308 in selected training periods: T training periods 408A, . . . , 408N may be divided into S subperiods, S(m), where ΣS(m)=T. Rather than sample every training period in T, data x[i] may be selected every T/P training period (where P may be any positive number), and where each T/P training period is a selected training period such that U comprises the total set of selected training periods, and U⊂T.

In ADSL, for example, there may be 32 upstream carrier subchannels, where each one carries 2 data samples for a total of 64 data samples. Furthermore, there may be 256 downstream carrier subchannels, where each one carries 2 data samples, for a total of 512 data samples, and T=1000 training periods. Therefore, in one example, TDQ training in downstream direction may be performed with every 224 (one half of 448=512−64) data samples from data sample set 308 per T/2=500 training periods, where every 500^{th} training period is a selected training period. As another example, TDQ training may be performed every 112 (one quarter of 448=512−64) data samples per T/4=250 training periods, where every 250^{th} training period is a selected training period.

Conclusion

Therefore, in one embodiment, a method may comprise receiving a communication having a data sample set, generating a selective data sample set based, at least in part, on the data sample set, and using the selective data sample set to update a training algorithm using an updating algorithm.

Embodiments of the invention may reduce the complexity and cost of using updating algorithms, such as LMS. By generating a selective data sample set, the complexity of training algorithms may be reduced, thereby significantly reducing both processing time, MIPS and memory spaces (such as, CPU and RAM spaces) because less processing may be needed. Also, by providing pre-training phase training coefficients, training algorithms may additionally converge fast and reliably.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

1. A method comprising:
receiving a communication having a data sample set;
generating a selective data sample set based, at least in part, on the data sample set; and
using the selective data sample set to update a training algorithm using an updating algorithm.

2. The method of claim 1, wherein said generating the selective data sample set comprises selecting a subset of the data sample set.

3. The method of claim 1, wherein said selecting a subset of the data sample set comprises selecting a subset of the data sample set in each training period in a training phase.

4. The method of claim 3, wherein said selecting a subset of the data sample set comprises selecting a subset of the data sample set in one or more selected training periods in a training phase.

5. The method of claim 1, wherein said generating the selective data sample set comprises selecting data from the data sample set in one or more selected training periods in a training phase.

6. The method of claim 5, wherein said selecting data from the data sample set in one or more selected training periods in a training phase comprises selecting all the data from the data sample set in the one or more selected training periods.

7. The method of claim 5, wherein said selecting data from the data sample set in one or more selected training periods in a training phase comprises selecting a subset of the data from the data sample set in the one or more selected training periods.

8. The method of claim 1, wherein the updating algorithm comprises a LMS (least mean square) algorithm.

9. The method of claim 1, wherein the communication is received on an ADSL (asymmetric digital subscriber line) modem.

10. The method of claim 9, wherein the data sample set comprises a symbol in an ADSL system.

11. The method of claim 1, additionally comprising using pre-training phase training coefficients in the updating algorithm.

12. A method comprising:
obtaining a set of pre-training phase training coefficients;
receiving a communication having a data sample set;
generating a selective data sample set based, at least in part, on the data sample set; and
using the set of pre-training phase training coefficients and the selective data sample set to update a training algorithm using an updating algorithm.

13. The method of claim 12, wherein said generating the selective data sample set comprises selecting a subset of the data sample set.

14. The method of claim 12, wherein said generating the selective data sample set comprises selecting data from the data sample set in one or more selected training periods in a training phase.

15. The method of claim 12, wherein the updating algorithm comprises an LMS (least mean square) algorithm.

16. An apparatus comprising:
circuitry capable of:
receiving a communication having a data sample set;
generating a selective data sample set based, at least in part, on the data sample set; and
using the selective data sample set to update a training algorithm using an updating algorithm.

17. The apparatus of claim 16, wherein said circuitry is additionally capable of selecting a subset of the data sample set.

18. The apparatus of claim 16, wherein said circuitry is additionally capable of selecting data from the data sample set in one or more selected training periods in a training phase.

19. The apparatus of claim 16, wherein said circuitry is additionally capable of using pre-training phase training coefficients in the updating algorithm.

20. A system comprising:
a circuit card;
circuitry communicatively coupled to the circuit card, and capable of:
receiving a communication having a data sample set;
generating a selective data sample set based, at least in part, on the data sample set; and
using the selective data sample set to update a training algorithm using an updating algorithm.

21. The system of claim 20, wherein the circuit card is an ADSL (asymmetric digital subscriber line) modem.

22. The system of claim 21, wherein the updating algorithm comprises a LMS (least mean square) algorithm.

23. The system of claim 20, wherein said circuitry is additionally capable of using pre-training phase training coefficients in the updating algorithm.

24. A machine-readable medium having stored therein instructions that, when executed by a machine, result in the following operations:
receiving a communication having a data sample set;
generating a selective data sample set based, at least in part, on the data sample set; and
using the selective data sample set to update a training algorithm using an updating algorithm.

25. The machine-readable medium of claim 24, wherein said instructions, when executed, additionally result in the machine selecting a subset of the data sample set.

26. The machine-readable medium of claim 24, wherein said instructions, when executed, additionally result in the machine selecting data from the data sample set in one or more selected training periods in a training phase.

27. The machine-readable medium of claim 24, wherein said instructions, when executed, additionally result in the machine using pre-training phase training coefficients in the updating algorithm.
